(19) United States
(12) Patent Application Publication
(10) Pub. No.: US 2003/0176248 A1
(43) Pub. Date: Sep. 18, 2003

(54) Belt installation tool

(76) Inventors: Marc De Meester, Flanders (BE); Adelbrecht Vanheusden, Erembodegem (BE)

Correspondence Address: Jeffrey Thurnau, The Gates Corporation, Mail Stop 31-4-1-A3, 900 S. Broadway, Denver, CO, 80209, US

(21) Appl. No.: 10/382,411

(22) Filed: Mar. 5, 2003

Related U.S. Application Data
(60) Provisional application No. 60/364,818, filed on Mar. 15, 2002.

(51) Int. Cl. F16H 7/22

(52) U.S. Cl. 474/130

(57) ABSTRACT

The invention comprises a tool for installing a low modulus type power transmission belt on an engine pulley. More particularly on a pulley having two sets of grooves whereby two power transmission belts are engaged with the pulley. The tool comprises a substantially semi-circular form having at least two surfaces engaged with a rim and which project radially therefrom. Each of the two surfaces also describe a helical angle with respect to an axis of rotation of the pulley. The first surface urges a belt into a first set of pulley grooves during a first tool rotation. The second surface urges the belt from the first set of pulley grooves to a second adjacent set of pulley grooves during a second rotation of the tool.

### FIELD OF THE INVENTION

The invention relates to a belt installation tool, more particularly, to a belt installation tool having cooperating helical surfaces for installing two power transmission belts on a dual groove set pulley.

### BACKGROUND OF THE INVENTION

Belt drive systems comprise a significant and widely used form of mechanical power transmission. Generally a belt runs between two or more pulleys, more particularly a driver and driven pulley.

In order to efficiently transmit power between the pulleys the belt is installed with a predetermined preload or tension. The amount of tension required is generally a function of the horsepower and torque requirements of the drive. An increased horsepower or torque requirement will generally require a commensurate increase in the tension of the belt.

In order to achieve the proper tension, one or more of the pulleys is loosened so the shaft or shafts can be moved to allow a slack condition in the belt. Then, the belt is looped over the pulleys. The loosened pulley or pulleys are then pulled or tightened in a predetermined position, resulting in a tension in the belt. This process requires the pulley(s) to be mechanically adjusted to properly tension the belt.

Belts may be installed on pulley systems using other methods. For systems with an automatic tensioning device the tensioner is loaded, the belt is placed in an operating position, and the tensioner is released to its operational location. For systems without a tensioner, belts are wrapped around the pulleys and then a pulley is tightened to its final location by a bracket or similar devices.

Another method of installing a belt involves use of a tool that presses the belt into a pulley groove without the need for mechanically adjusting the pulleys. The tool is used adjacent to a pulley. It extends the belt while laterally forcing it into a pulley groove.

Representative of the prior art is European Patent No. 0 831 247 B1 to Hutchinson which discloses a tool having a radial thrust area resting against a girth of the pulley, keeping a belt away from a pulley until it reaches a plane spaced from a pulley surface.

Also representative of the art is U.S. Pat. No. 4,193,310 (1980) to Boyer et al. which discloses a pulley having a diverging means extending radially and laterally from the rim for engaging and seating the belt on the pulley rim. This invention does not comprise a bearing surface for gradually entraining a belt on a pulley, instead having a peg that abruptly bends the belt into the pulley groove.

The prior art apparatus forces a belt to bend over small radius portions of the tool, causing high stress concentrations that damage the belt during installation. Further, high lateral loads damage the sidewalls of the belt. The transverse motion of the belt as it moves into the pulley groove may also damage the belt. Further, the prior art tools do not allow installation of two belts on a dual groove set pulley.

What is needed is a belt installation tool for efficiently installing two belts on a dual groove set pulley. What is needed is a belt installation tool having cooperating helical surfaces. The present invention meets these needs.

### SUMMARY OF THE INVENTION

The primary aspect of the invention is to provide a belt installation tool for efficiently installing two belts on a dual groove set pulley.

Another aspect of the invention is to provide a belt installation tool having cooperating helical surfaces.

Other aspects of the invention will be pointed out or made obvious by the following description of the invention and the accompanying drawings.

The invention comprises a tool for installing a low modulus type power transmission belt on an engine pulley. More particularly on a pulley having two sets of grooves whereby two power transmission belts are engaged with the pulley. The tool comprises a substantially semi-circular form having at least two surfaces engaged with a rim and which project radially therefrom. Each of the two surfaces also describe a helical angle with respect to an axis of rotation of the pulley. The first surface urges a belt into a first set of pulley grooves during a first tool rotation. The second surface urges the belt from the first set of pulley grooves to a second adjacent set of pulley grooves during a second rotation of the tool.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the tool.

FIG. 2 is a plan view of the tool.

FIG. 3 is a side view of the tool.

FIG. 4 is a side view of the tool.

FIG. 5 is a side view of the tool on a pulley.

### DETAILED DESCRIPTION OF THE PREFERRED EMBODIMENT

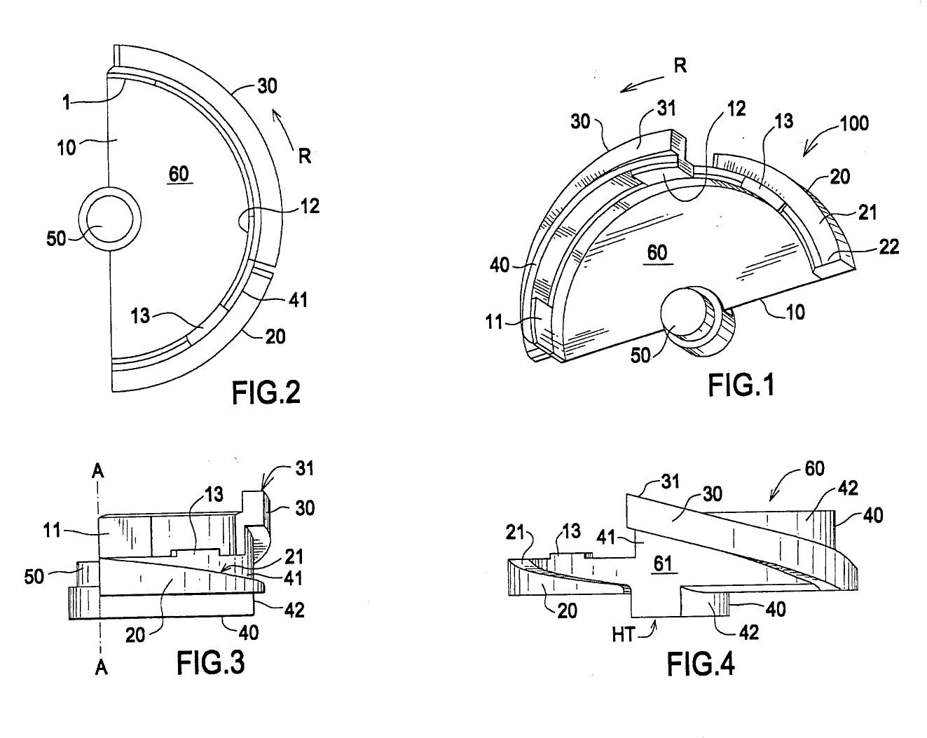

FIG. 1 is a perspective view of the tool. Tool 100 comprises urging member 20 and urging member 30. Urging member 20 and urging member 30 each project radially from rim 40.

Rim 40 is connected to web 10. At a center of web 10 is tool receiving portion 50.

Urging member 20 comprises surface 21. Surface 21 has a substantially planar form which is engaged with arcuately shaped rim 40. Urging member 30 comprises surface 31. Surface 31 has a substantially planar form which is engaged with arcuately shaped rim 40. Each of surface 21 and surface 31 describe a substantially helical form with respect to a tool axis of rotation when viewed from a tool side, see FIG. 3 and FIG. 4.

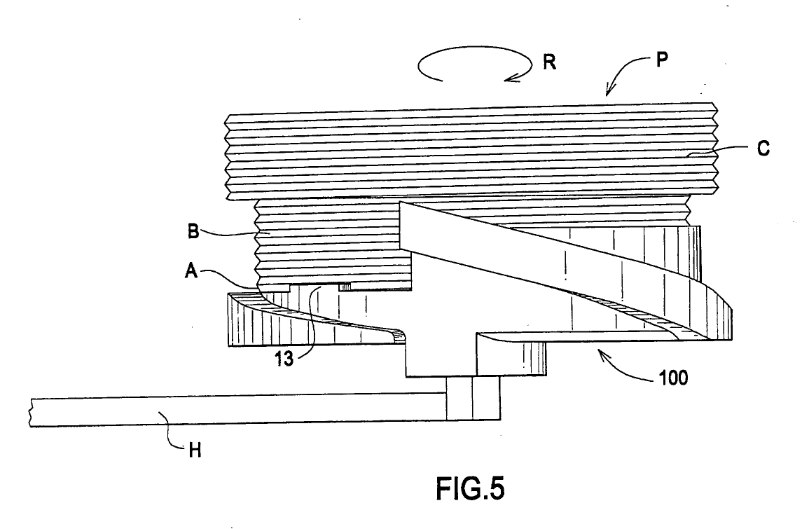

Members 11, 12 extend substantially radially inward from rim 40. Members 11, 12 engage a belt engaging surface, or grooves, of a pulley (see FIG. 5, items B and C). Tab 13 extends radially inward toward a tool center of rotation. Tab 13 engages a pulley rim (see FIG. 5) when the tool is in use.

Handtool engaging portion 50 is disposed substantially at a tool center of rotation.

FIG. 2 is a plan view of the tool. Urging member 20 and urging member 30 extend about a circumference of the tool 100 on rim 40. Urging member 30 extends through an arc generally exceeding 90°. Urging member 20 extends through an arc generally less than 90°. Tool 100 extends through a total arc of approximately 180°. This is to facilitate engagement and removal of the tool with respect to a pulley during a belt installation.

FIG. 3 is a side view of the tool. Urging member 20 and urging member 30, and more particularly, surface 21 and surface 31 each describe a substantially helical angle with respect to an axis of rotation A-A.

FIG. 4 is a side view of the tool. The helical form of surface 21 and surface 31 is clearly shown. Belt engaging surface 42 describes a substantially arcuate surface extending toward a tool center.

In use side 60 of tool 100 is engaged with a side of a pulley upon which pulley a belt is to be installed. The tool is ideally adapted for installing a low modulus type power transmission belt, or endless member, on a dual groove set pulley. A low modulus power transmission belt has a capacity for elongation when subjected to a tensile load. A dual groove set pulley comprises two sets of grooves for engaging two power transmission belts, including for example, multi-ribbed power transmission belts, see FIG. 5. The tool may also be used to install a low modulus type belt in a single belt pulley as well.

As shown in FIG. 1 and FIG. 5 the tool is placed upon the pulley. The tool is engaged with a pulley P rim A and with a first set of pulley grooves B. Tab 13 engages with the pulley rim and members 11, 12 engage with the first set of pulley grooves B. A belt is first loosely placed upon the tool so that it engages the tool in slot 61 and upon surface 41 and surface 42. The tool is turned in direction R as shown in FIG. 1 by engaging a handtool H at HT in handtool engaging portion 50. The handtool may comprise any form of ratchet tool or other tool for engaging a socket known in the art.

FIG. 5 is a side view of the tool on a pulley. In FIG. 5 a multi-ribbed surface is depicted for first set of pulley grooves B and second set of pulley grooves C. The first set of pulley grooves B are shown having a different radius than the second set of pulley grooves C. The radius of the tool is pre-determined in order to properly engage a pulley as shown. Of course, the radius of grooves B and grooves C may be equal as required by a user. Handtool H is shown engaged with the tool.

As the tool is turned, the belt is urged into a first set of pulley grooves B by a lateral pressure from surface 21. The tool is rotated through one rotation which is sufficient to install a belt into the first set of pulley grooves B. The tool is then started through another rotation. In doing so, surface 31 comes into engagement with a belt side in the first set of pulley grooves. As the tool is further rotated, surface 31 then laterally urges the belt into a second set of pulley grooves C, by a lateral pressure, which set of grooves are adjacent to the first set of pulley grooves B. The tool is rotated through a second complete rotation which is sufficient to install the belt into the second set of pulley grooves C. Once the belt is installed in the second set of pulley grooves B, a second belt is installed in the first set of pulley grooves as previously described. Once the second belt is installed in the first set of pulley grooves, the tool is removed.

Although a single form of the invention has been described herein, it will be obvious to those skilled in the art that variations may be made in the construction and relation of parts without departing from the spirit and scope of the invention described herein.

We claim:

1. A tool comprising:
a first urging member;
a second urging member;
the first urging member having a surface projecting radially from a tool center describing a substantially helical form with respect to a tool axis;
the second urging member having a surface projecting radially from a tool center describing a substantially helical form with respect to a tool axis; and the first urging member and the second urging member disposed about a tool rim to sequentially engage an endless member.

2. The tool as in claim 1 further comprising:
a member projecting radially toward a tool center from the tool rim for engaging a pulley groove.

3. The tool as in claim 1 further comprising:
a member projecting radially toward a tool center from the tool rim for engaging a pulley rim.

4. The tool as in claim 1 further comprising:
a handtool engaging portion disposed substantially at a tool center of rotation.

5. The tool as in claim 1 further comprising:
a web extending from a tool center to a tool rim.
